(19) United States
(12) Patent Application Publication
(10) Pub. No.: US 2016/0036725 A1
(43) Pub. Date: Feb. 4, 2016

(54) Multi-Dimension Topology Mapper for SaaS Applications

(71) Applicant: Corent Technology, Inc., Aliso Viejo, CA (US)

(72) Inventors: Shafiullah Syed, Saratoga, CA (US); Balakrishnan Ramalingam, Trichy (IN); Sethuraman Venkataraman, Thiruninravur (IN); Jeya Anantha Prabhu, Chennai (IN)

(21) Appl. No.: 14/815,826

(22) Filed: Jul. 31, 2015

Related U.S. Application Data
(63) Continuation of application No. 14/814,625, filed on Jul. 31, 2015.
(60) Provisional application No. 62/031,698, filed on Jul. 31, 2014.
(60) Provisional application No. 62/031,712, filed on Jul. 31, 2014.

(51) Int. Cl. H04L 12/911; H04L 29/08

(52) U.S. Cl. CPC H04L 47/829; H04L 67/10

(57) ABSTRACT

A system that generates deployment topology maps for various modules of a non-tenant-aware application to migrate to a tenant-aware application on a tenant-aware cloud-based infrastructure. The system analyzes the non-tenant-aware application and constructs various deployment topology maps for the non-tenant-aware application, and then maps the deployment topology maps to the virtualized cloud-based infrastructure. Various migration plans are then developed to assist in deployment of the non-tenant-aware application to the cloud-based infrastructure to create a tenant-aware application installed on the cloud-based infrastructure.

This application is a continuation of U.S. Pat. No. 14/814625, filed Jul. 31, 2015, which claims the benefit of priority to U.S. Provisional Application No. 62/031712, filed Jul. 31, 2014. This application also claims the benefit of priority to U.S. Provisional Application No. 62/031698, filed Jul. 31, 2014. All extrinsic materials identified herein are incorporated by reference in their entirety.

### FIELD OF THE INVENTION

The field of the invention is software applications and services.

### BACKGROUND OF THE INVENTION

The background description includes information that maybe useful in understanding the present invention. It is not an admission that any of the information provided herein is prior art or relevant to the presently claimed invention, or that any publication specifically or implicitly referenced is prior art.

Computer environments have evolved from localized single user systems, to multi-user systems accessible by geographically distributed users. More recently, as cloud resources have become available, there has been a push to migrate one or more aspects (computer power, memory, storage, etc) of what were previously localized systems into the cloud. This can be done for many reasons, including efficient allocation of resources, cost-effective scalability, improved reliability, improved security, and greater accessibility.

There are numerous issues that arise in executing such migrations, including especially time and cost. For example, many applications are not well suited to a particular cloud environment because (a) cloud environments and their resources are available in a wide variety of configurations and may not pair well with the application's requirements, (b) legacy applications may fail to take advantage of the additional resources offered by a cloud environment and/or (c) applications run inefficiently in a cloud. Before migrating local software applications into a cloud environment, it is helpful to match and compare a local software application's hardware, software, network, and other application environment resources with the resources of any cloud environments considered for migration. The matching and comparing reveals compatibility, costs, and other software migration factors that can serve as a basis for the selection of a proper cloud environment or environments.

Thus, there is still a need for systems and methods that efficiently adapt legacy software applications so they may take advantage of the resources and benefits of a cloud environment, including migrating non-tenant aware software applications into applications that can be operated in tenant applications in a SaaS (Software as a Service) environment. One particular need is to map the deployment of software application modules to various available cloud resources.

### SUMMARY OF THE INVENTION

The inventive subject matter provides apparatus, systems, and methods in which the modules of a software application are mapped onto the various resources available within and among one or more cloud environments by use of an application mapping engine, a cloud mapping engine, and a rendering engine.

The application mapping engine is preferably configured to analyze the interdependencies of the modules of one or more applications. Based on the interdependencies, the engine groups those modules together that are interdependent on each other. The engine creates as many permutations of module arrangements as is reasonably possible or as determined by a user or administrator.

The cloud mapping engine is preferably configured to receive each module arrangement created by the application mapping engine and to generate cloud maps based on the available cloud resources. For the cloud maps, the cloud mapping engine assigns as many or as few module groupings from the module map to individual cloud resources. The cloud map combines as many or as few individual cloud resources from a single or multiple clouds to generate the cloud map. The cloud mapping engine not only generates all permutations of cloud maps for a single module map, but can also generate all permutations of cloud maps for each of the module maps generated by the application mapping engine.

In another embodiment of the inventive subject matter, a cloud map database is used to store at least some of the cloud maps generated by the cloud mapping engine.

Also contemplated is an analysis engine to rank the desirability of each particular cloud map based on criteria set by a user or operator, which includes scalability, self-healing, resource availability, cost of infrastructure, and cost of maintenance. The analysis engine can be used in combination with the cloud map database to store all permutations of cloud maps with a desirability ranking included.

Viewed from another perspective, the inventive subject matter provides apparatus, systems and methods that matches local application requirements with cloud resources, transforms any SaaS service deficient application into SaaS capable applications, and non-tenant aware applications into at least appearance of tenant-aware applications, maps the applications efficiently to the cloud resources, and monitors and meters users consumption of cloud resources and SaaS services.

In order to assess the compatibility, benefits, and other software migration factors for migrating one or more locally operated software applications to one or more cloud environments, it is helpful if the modules of each application are mapped onto appropriate cloud environment resources. In order to provide a comprehensive analysis, it can be advantageous to generate as many maps of the application modules as possible, and then apply each module map to the cloud environment resources in as many variations as possible. Once a full list of possible configurations to map the application modules to the cloud environment has been generated, the user can select the most desirable configuration based time, speed, power, cost, or other performance factors.

In one class of preferred embodiments, the inventive subject matter of the present invention relates to the mapping of at least one software application, each of which comprises at least one module, to the cloud resources of at least one cloud environment. This mapping maybe accomplished by compiling at least some but preferably all possible permutations for grouping interrelated modules within a set of software applications. This mapping may further be performed by compiling at least some but preferably all possible configurations for mapping the compilation of module groupings to the available cloud resources. Such cloud resources may exist on a single cloud or on a multitude of clouds. A report of the overall mapping compilation can provide information to help a user select an optimal, non-optimal, or some degree in between, cloud mapping configuration based on the opinion of the user. Such a compilation of cloud mapping configurations can also help a user to implement a selected cloud configuration and/or backup cloud configurations for a particular set of software applications.

The inventive subject matter further provides apparatus, systems, and methods in which a multi-dimension topology mapper is the interface module that analyzes an application or a SaaS application and identifies its interdependent modules to create multiple topology maps of the application. A topology map is a description of the application with interdependent modules that are suitable for deployment on computer resources. Different topology maps can represent the same application but utilize different computer and storage resources to account for different deployment configurations that deliver varying levels of performance, scalability, and redundancy. Once these topology maps are developed, each topology map can be used to create one or more cloud maps. A cloud map is a physical map of cloud resources used to implement every node in the Application topology map. Just as an application can be represented by multiple application topology maps, it also possible to represent every application topology map with multiple cloud maps giving a multi-dimension mapping of an application, which can be moved to the Cloud. These cloud maps of every application topology will utilize different clouds and different cloud resources as appropriate to implement the application on the Cloud.

Once a cloud environment or multiple environments have been selected for a single or multiple local software applications, each software application is preferably transformed to operate in each home cloud environment to facilitate the application (a) running efficiently in the cloud environment, and/or (b) taking advantage of additional resources offered by a cloud environment. Software applications can be individually re-written to resolve those issues, but it is often desirable to provide an automated process for transforming existing software applications (which might be locally based) to operate efficiently in a cloud environment. An automated process for transforming a locally operated software application into a cloud operated software application reduces the delay and cost required to migrate a local application into the cloud.

Once one or more locally operated applications have been migrated into the cloud and configured to operate in the cloud environment, most or even all operations or workloads engaged by the application will likely be performed by the cloud environment resources. In order to efficiently utilize cloud resources, it is helpful to first divide the application's workloads into related groups or partitions, and then assign each partition to a cloud resource. The assignment of partitions to cloud resources can be based on time, speed, power, cost, or other performance factors, that are most desirable for the user.

Once one or more software applications are available for operation in one or more cloud environments, it is desirable to measure and/or meter each user's use of any applications, and each application's use of cloud resources. This metering can be used to charge individual users and/or groups of users for the cost of cloud resources actually consumed by the users rather than based on storage limits, time limits, processor limits, or other forms of block billing. This metering can also be used to charge individual users of the same application separately, based on the user's actual use rather than block billing. This is beneficial because it allows cost sensitive users greater control over the cost of cloud based applications, and allows cloud operators to more efficiently assign and bill for available resources.

In interpreting descriptions in this Specification, groupings of alternative elements or embodiments of the inventive subject matter are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic illustrating how an application can be represented in different topologies and each topology can be mapped to multiple cloud instance maps.

FIG. 2 is a schematic depicting the system with multiple interface modules to analyze an application and create its corresponding application topology maps as well as cloud resource maps.

### DETAILED DESCRIPTION

The following description includes information that may be useful in understanding the present invention. It is not an admission that any of the information provided herein is prior art or relevant to the presently claimed invention, or that any publication specifically or implicitly referenced is prior art.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Computer devices that are

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Various objects, features, aspects and advantages of the inventive subject matter will become more apparent from the following detailed description of preferred embodiments, along with the accompanying drawing figures in which like numerals represent like components.

It should be noted that any language directed to a computer or a computer system should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

Regarding transformation of a non-tenant aware application to an application that operates with multiple tenants, one could modify the application according to teachings of WO2008042984 (Hofhansl) and US20100005055 (An), or modify the application environment context according to teachings of U.S. Pat. No. 8,326,876 (Venkatraman) or US2010/0005443 (Kwok). Co-owned U.S. Pat. No. 8,326,876 (Venkataraman) also discloses multi-tenant agile database connectors that could be used to transform a locally-based application into a multi-tenant application system.

These and all other publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

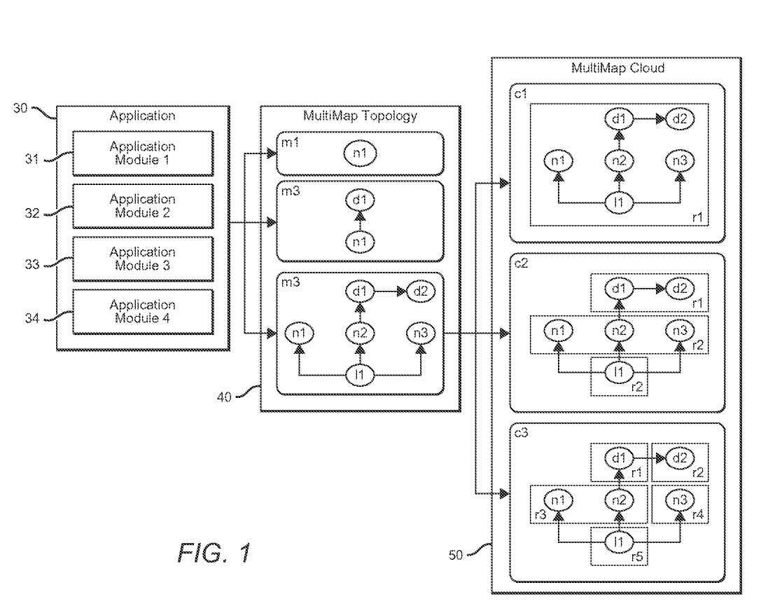

FIG. 1 is a schematic illustrating how an application 30 could be represented in different topologies and how each topology can be mapped to multiple cloud instance maps.

Reference 30 represents an application consisting of multiple interdependent software modules 31, 32, 33 and 34. Application 30 has multiple deployment topologies. These multiple topologies represent a single application as having a multimap topology shown at reference 40. The three example application topologies m1, m2 and m3 are shown as part of the topology list Of 40. Topology m1 is a simple topology representing an entire module represented as a single node n1 installed on a single logical partition. Topology m2 shows a more complex topology showing a first main node d1 installed on a first logical partition, and a second node n1 installed on a second logical partition, where the first node dl accesses data from the second node n1, for example by making function calls to n1 or by retrieving saved data from n1. Topology m3 shows an even more complex topology, dividing up a module into several sub-nodes with complex topologies.

The different application deployment topologies generated by the system can be created considering one or more operations, such as by using auto scaling, clustered deployment and self-healing and/or economic factors related to the cost of maintaining the application configuration the different instances on the cloud. Preferably, the system exhaustively creates every known deployment topology for each application module so as to explore every option of deployment.

Each deployment topology can have one or more cloud mappings, which is a mapping of the multimap deployment topology to logical sections of the cloud. The deployment topology m3 is shown to have three cloud maps c1, c2 and c3, as shown as multimap cloud 50. Each of maps c1, c2 and c3 could be logically mapped to a different set of cloud resources, physically mapped to a different set of cloud resources located in different geographical areas (e.g. cloud c1 is located in a first building and cloud 2 is located in a second building), or more than one deployment topology could be mapped to the same cloud (e.g. m2 and m3 are both mapped to c3). Preferably, the system exhaustively creates every known cloud mapping for each deployment topology map so as to explore every option of deployment onto the cloud. Preferably, each of the cloud maps represents a physical resource that modules of application 30 would be deployed to. In essence, the schematic of FIG. 1 shows a logical map of an application mapped to a logical deployment map mapped to a physical resource map.

It's possible to establish multiple cloud resource groups so that different cloud resource groups can be mapped to the same cloud or to different clouds to deploy the application.

Each map of the cloud represents a mapping to different physical resources as shown for c2 where the topology nodes d1 and d2 are mapped to cloud instance r1, nodes n1, n2 and n3 are mapped to cloud instance r2 and node 11 is mapped to cloud resource r2.

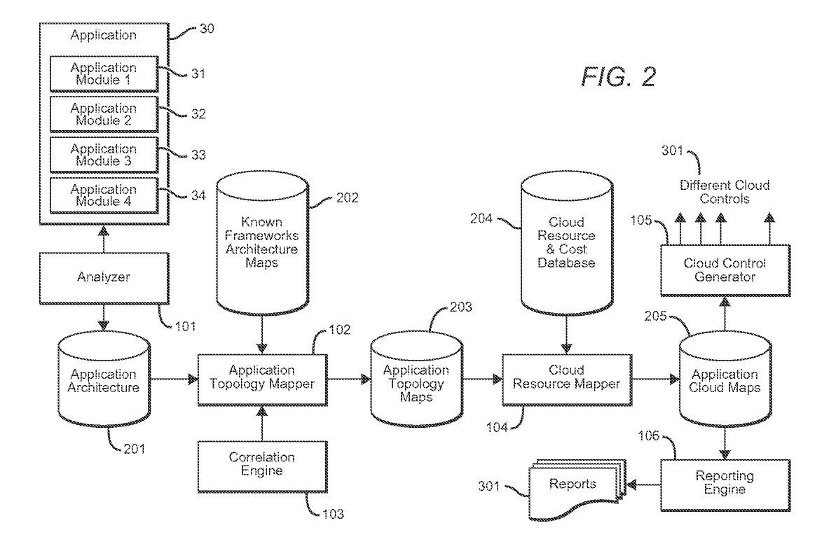

FIG. 2 is a schematic depicting a multi-tenant computer system with multiple interface modules to analyze an application and construct corresponding application topology maps for a tenant-aware cloud-based application prior as well as cloud resource maps prior to migration.

The application 30 consists of multiple program modules representing the functional elements of the application. The analyzer 101 scans the application, inspecting the different components of the application to create a scanned map that is stored in the database 201. The correlation engine 103 helps the topology mapper 102 relate information between known architectures 202 and application topology 102. The application topology mapper 102 reads the application scanned map from 201 and along with additional information from known frameworks and architectures 202, correlates the information to create different application deployment topologies.

The newly created application topologies are stored in the 202 application topology maps.

For each application topology map read from the database 203, cloud resource mapper 104 creates multiple application cloud maps. The information on cloud resources is used from cloud resource and cost database 204. The resulting application cloud maps are stored in application cloud map database 205. As used herein an “application cloud map” is a migration plan that could be used to migrate the plurality modules to one of the cloud maps. Preferably, the application cloud map could be sent to a multi-tenant migration system, such as the system taught in co-pending U.S. Pat. No. 8,326,876 (Venkataraman), to assist in properly migrating one or more of the application modules (particularly in a non-tenant-aware application) to resources in the cloud (particularly to a tenant-aware application).

Reporting engine 106 can create multiple reports 301 on different topologies desired by the user. The cloud control generator 105 can directly generate control scripts, or API calls, to the cloud to create and manage these topologies on a specific cloud or multiple clouds. Generally, reporting engine 106 generates report 301 by creating a visual representation of the migration plan saved in database 205.

What is claimed is:

1. A system for mapping computer resources, comprising:
an analyzer configured to analyze a non-tenant-aware application and identify a plurality of modules of the non-tenant-aware application and attributes of the plurality of modules;
an application mapping engine configured to generate at least a first and a second module deployment topology map as a function of the attributes of the plurality of modules, wherein each module deployment topology map represents a way of deploying the non-tenant-aware application on a computer system;
a cloud mapping engine configured to generate a first cloud map as a function of the first module deployment topology map and a second cloud map as a function of the second module deployment topology map;
a rendering engine that configures a rendering device to generate a migration plan to migrate the plurality of modules to at least one of the first cloud map and the second cloud map.

2. The system of claim 1 wherein the application mapping engine is configured to exhaustively construct all possible permutations of module deployment topology maps for the plurality of modules.

3. The system of claim 1 wherein the cloud mapping engine is configured to exhaustively construct all possible permutations of cloud maps as a function of the module deployment topology maps generated by the application mapping engine.

4. The system of claim 1 further comprising a cloud map database functionally coupled to the cloud mapping engine to save the first cloud map and the second cloud map.

5. The system of claim 1 further comprising an analysis engine configured to rank the first cloud map and the second cloud map relative to one another in accordance with a preferred attribute.

6. The system of claim 5 wherein the preferred attribute is selected from the group consisting of scalability, self-healing, availability, cost of infrastructure, and cost of maintenance.
